(19) United States
(12) Patent Application Publication
(10) Pub. No.: US 2020/0324720 A1
(43) Pub. Date: Oct. 15, 2020

(54) BUMPER DEVICE FOR AN AUTOMOTIVE VEHICLE

(71) Applicant: GM GLOBAL TECHNOLOGY OPERATIONS LLC, DETROIT, MI (US)

(72) Inventors: Jacob Wright, Grosse Pointe Woods, MI (US); Amlanjyoti Barman, Troy, MI (US); Andre T. Matsumoto, Sterling Heights, MI (US); Julie A. Bryce, Novi, MI (US)

(21) Appl. No.: 16/379,317

(22) Filed: Apr. 9, 2019

(51) Int. Cl. B60R 19/18; B60R 19/02

(52) U.S. Cl. CPC B60R 19/18; B60R 2019/186; B60R 2019/1886; B60R 19/023

(57) ABSTRACT

An automotive vehicle includes a vehicle body, a bumper beam coupled to the vehicle body, and a fascia coupled to the vehicle body and extending about the bumper beam. The vehicle further includes an expansion member coupled to the bumper beam and disposed between the bumper beam and the fascia. The expansion member has an initial position with respect to the bumper beam and a deployed position with respect to the bumper beam. In the initial position the expansion member presents a first frontal height and in the deployed position the expansion member presents a second frontal height. The second frontal height exceeds the first frontal height and a bumper beam height. The expansion member is configured to deploy from the initial position to the deployed position in response to contact by the fascia.

### TECHNICAL FIELD

The present disclosure relates to automotive vehicles, and more particularly to bumper structures of automotive vehicles. A vehicle typically includes a body structure having a bumper beam attached thereto. The bumper beam is provided to receive and dissipate forces applied to the exterior of the vehicle, e.g. as may occur during a collision. Such bumper beams accommodate a variety of design considerations, including collision requirements, airflow requirements, and stylistic requirements.

### SUMMARY

An automotive vehicle according to the present disclosure includes a vehicle body having a width direction, a fore portion, and an aft portion. The vehicle additionally includes a bumper beam coupled to the vehicle body. The bumper beam has a long dimension oriented in the width direction, and a bumper beam height in a vertical direction orthogonal to the width direction. The vehicle also includes a fascia assembly coupled to the vehicle body and extending about the bumper beam. The vehicle further includes an expansion member coupled to the bumper beam and disposed between the bumper beam and the fascia assembly. The expansion member has an initial position with respect to the bumper beam and a deployed position with respect to the bumper beam. In the initial position the expansion member presents a first frontal height and in the deployed position the expansion member presents a second frontal height. The second frontal height exceeds the first frontal height and exceeds the bumper beam height. The expansion member is configured to deploy from the initial position to the deployed position in response to contact by the fascia assembly.

In an exemplary embodiment, the expansion member is hingedly coupled to the bumper beam, and the expansion member is configured to deploy through pivoting motion about the hinged coupling. In such embodiments, the hinged coupling may have a pivot axis extending generally parallel to the width direction.

In an exemplary embodiment, the expansion member comprises a rigid member fixedly coupled to the bumper beam. The expansion member is configured to inelastically deform in response to contact by the fascia assembly. In such embodiments, the expansion member may have an elongate upper portion, an elongate lower portion, and a curved central portion coupling the upper portion to the lower portion. In the initial position the central portion defines a foremost region of the expansion member with the upper portion and lower portion extending generally aftward of the central portion. In the deployed position, the upper portion may extend above the bumper beam and the lower portion extends below the bumper beam.

A bumper assembly for an automotive vehicle according to the present disclosure includes a bumper beam. The bumper beam has a fore side, an aft side, a long dimension, and a bumper beam height in a vertical direction orthogonal to the long dimension. The assembly additionally includes an expansion member coupled to the fore side of the bumper beam. The expansion member has an initial position with respect to the bumper beam and a deployed position with respect to the bumper beam. In the initial position the expansion member presents a first frontal height and in the deployed position the expansion member presents a second frontal height. The second frontal height exceeds the first frontal height and exceeds the bumper beam height. The expansion member is configured to deploy from the initial position to the deployed position in response to contact from a body forward of the expansion member.

In an exemplary embodiment, the expansion member is hingedly coupled to the bumper beam, and the expansion member is configured to deploy through pivoting motion about the hinged coupling. In such embodiments, the hinged coupling may have a pivot axis extending generally parallel to the long dimension.

In an exemplary embodiment, the expansion member comprises a rigid member fixedly coupled to the bumper beam. The expansion member is configured to inelastically deform in response to contact by the body. In such embodiments, the expansion member may have an elongate upper portion, an elongate lower portion, and a curved central portion coupling the upper portion to the lower portion. In the initial position the central portion defines a foremost region of the expansion member with the upper portion and lower portion extending generally aftward of the central portion. In the deployed position, the upper portion may extend above the bumper beam and the lower portion extends below the bumper beam.

Embodiments according to the present disclosure provide a number of advantages. For example, a bumper assembly according to the present disclosure may present a relatively narrow fore portion, providing stylistic freedom and adequate airflow performance, while also enabling desirable bumper performance.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is an illustrative view of an automotive vehicle according to an embodiment of the present disclosure;

FIGS. 2A and 2B are schematic illustrations of a bumper assembly according to a first embodiment of the present disclosure;

FIGS. 3A and 3B are schematic illustrations of a bumper assembly according to a second embodiment of the present disclosure;

FIGS. 4A and 4B are schematic illustrations of a bumper assembly according to a third embodiment of the present disclosure; and

FIGS. 5A and 5B are schematic illustrations of a bumper assembly according to a fourth embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desirable for particular applications or implementations.

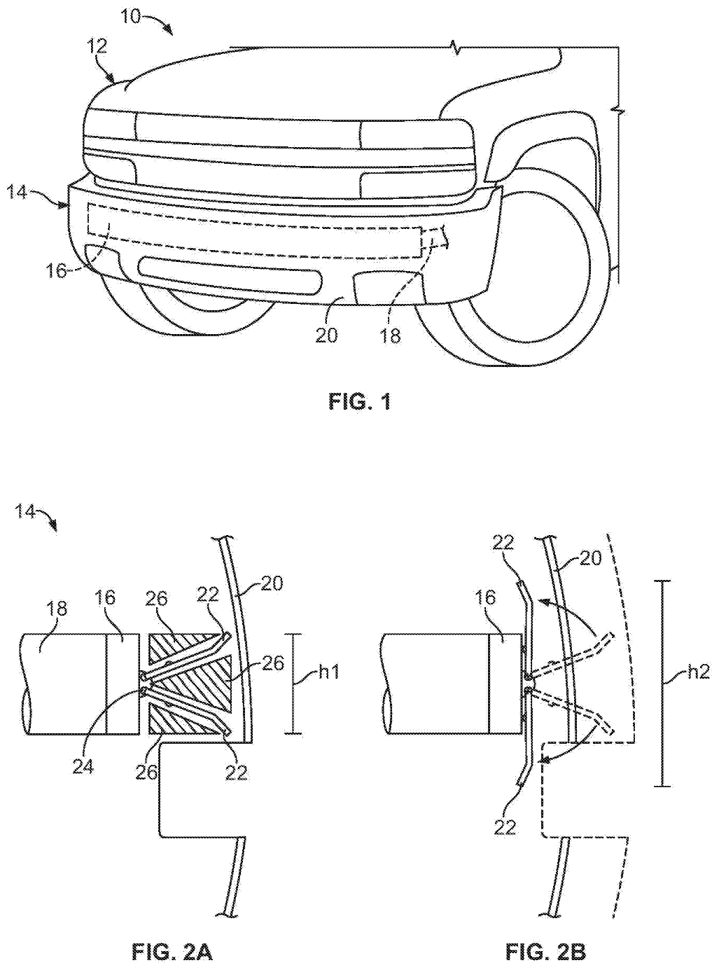

Referring now to FIG. 1, an automotive vehicle 10 according to an embodiment of the present disclosure is illustrated. The vehicle 10 has a body 12. At least one bumper assembly 14 is coupled to the body 12. A front bumper 14 is shown at a fore portion of the body 12 in FIG. 1, and a back bumper 14 may also be provided at an aft portion of the body 12. In the illustrated embodiment the bumper assembly 14 has a long axis extending in a widthwise direction of the vehicle, i.e. generally orthogonal to a longitudinal axis of the body 12. However, as will be appreciated by one of ordinary skill in the art, similar bumper assemblies may likewise be arranged in other locations on the vehicle, e.g. as side bumpers extending generally parallel to the longitudinal axis of the body 12. The bumper assembly 14 includes a bumper beam 16. The bumper beam 16 is coupled to other structural members of the body 12 via one or more longitudinal rails 18. A fascia assembly 20 is disposed about the bumper beam 16. The fascia assembly 20 may form the exterior of the bumper assembly 14.

Referring now to FIG. 2A, a cross-section of a first embodiment of a bumper assembly 14 is illustrated schematically. In this embodiment, the bumper beam 16 is provided with at least one expansion member 22. In the embodiment illustrated in FIG. 2A, the bumper beam 16 is provided with two expansion members 22. The expansion members 22 are hingedly coupled to the bumper beam 16 via a hinge interface 24. In the illustrated embodiment the hinge interface is configured to permit the expansion members 22 to pivot relative to the bumper beam 16, with a pivot axis extending generally parallel to the long axis of the bumper beam. In an exemplary embodiment the expansion members 22 extend substantially the entire width of the bumper beam 16. However, in other embodiments the expansion members 22 may extend a smaller width, e.g. as a plurality of discrete expansion members arranged along the width of the bumper beam 16.

In an initial configuration, as shown in FIG. 2A, the expansion members 22 project generally forward of the bumper beam 16, e.g. generally toward the fascia assembly 20. In the initial configuration, an overall height of the expansion members 22, i.e. a vertical distance between an uppermost portion of the expansion members 22 and a lowermost portion of the expansion members 22, is h₁. In an exemplary embodiment, h₁ is equal to or less than a height of the bumper beam 16, i.e. a vertical distance between an uppermost portion of the bumper beam 16 and a lowermost portion of the bumper beam 16.

One or more portions of damping material 26, e.g. a foam material, plastic honeycombed structure, or other compressible material, may be disposed proximate the expansion members 22, e.g. between the expansion members 22 and the fascia assembly 20 and bumper beam 16. The damping material 26 may be secured to the expansion members 22, the fascia assembly 20 and/or the bumper beam 16, e.g. by adhesive.

As illustrated in FIG. 2B, in response to translational motion by fascia assembly 20 relative to the bumper beam 16, e.g. as may occur if the vehicle bumper assembly 14 collides with an object exterior to the vehicle 10, the expansion members 22 may be driven in pivoting motion about the hinge interface 24 to a deployed position. The damping material 26 may be crushed, ejected, or otherwise displaced while absorbing energy from the fascia assembly 20. In the deployed position, the expansion members 22 may contact the bumper beam 16, either directly or via one or more spacer members provided on the expansion members 22. In the deployed position, the expansion members 22 define an overall height h₂, where h₂ is greater than h₁. The expansion members thereby function to increase an overall height and, in turn, frontal surface area of the bumper beam 16. In a collision, impact forces may thereby be spread over a larger area, distributing the forces experienced by the bumper beam 16 and the object external to the vehicle 10.

As may be seen, the bumper assembly thereby provides a relatively low-profile initial shape, while also providing a relatively larger area for impact forces when necessary.

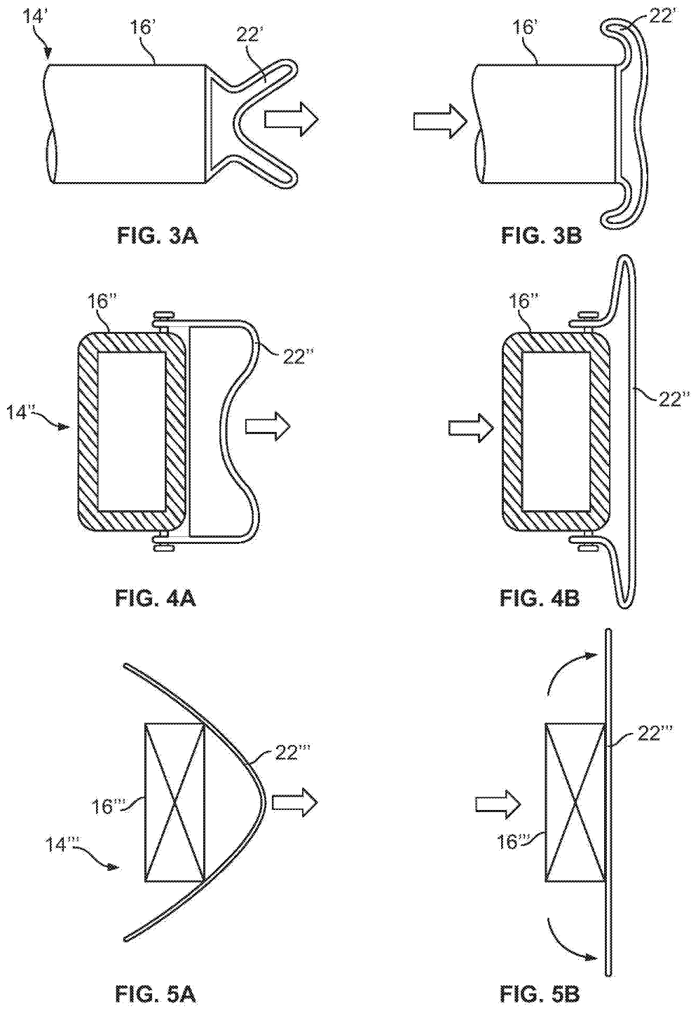

Referring now to FIGS. 3A and 3B, a cross-section of a second embodiment of a bumper assembly 14′ is illustrated schematically. In this embodiment, the bumper beam 16′ is provided with at least one expansion member 22′ in an initial configuration as illustrated in FIG. 3A. In this embodiment, the expansion member 22′ is an extruded member coupled to a fore portion of the bumper beam 16′. The expansion member 22′ is formed with a tapered portion forward of the bumper beam 16′ and at least one protrusion extending forward of the tapered portion. In response to application of force by the fascia assembly, the expansion member 22′ may inelastically deform as illustrated in FIG. 3B. During such deformation, the expansion member 22′ may dissipate energy from the collision. Moreover, in the deformed configuration illustrated in FIG. 3B, the overall height of the expansion member 22′ is increased relative to the initial configuration. The bumper assembly 14′ may thereby provide an increased area for impact forces when necessary, in a similar fashion as the embodiment discussed with respect to FIGS. 2A and 2B.

Referring now to FIGS. 4A and 4B, a cross-section of a third embodiment of a bumper assembly 14″ is illustrated schematically. This embodiment is broadly similar to that shown in FIGS. 3A and 3B. In this embodiment, the bumper beam 16″ is provided with at least one expansion member 22″ in an initial configuration as illustrated in FIG. 4A. In this embodiment, the expansion member 22″ is an extruded member coupled to a fore portion of the bumper beam 16″. The expansion member 22″ is formed with at least one protrusion extending forward of the bumper beam 16″. In response to application of force by the fascia assembly, the expansion member 22″ may inelastically deform as illustrated in FIG. 4B. During such deformation, the expansion member 22″ may dissipate energy from the collision. Moreover, in the deformed configuration illustrated in FIG. 4B, the overall height of the expansion member 22″ is increased relative to the initial configuration. The bumper assembly 14″ may thereby provide an increased area for impact forces when necessary, in a similar fashion as the embodiment discussed with respect to FIGS. 2A and 2B.

Referring now to FIGS. 5A and 5B, a cross-section of a fourth embodiment of a bumper assembly 14′″ is illustrated schematically. In this embodiment, the bumper beam 16′″ is provided with at least one expansion member 22′″ in an initial configuration as illustrated in FIG. 5A. In this embodiment, the expansion member 22′″ is an extruded member coupled to a fore portion of the bumper beam 16′″, e.g. at an uppermost portion of the bumper beam 16′″ as illustrated. The expansion member 22′″ is formed with an elongate upper portion, an elongate lower portion, and a curved central portion coupling the upper portion to the lower portion. In the initial position illustrated in FIG. 5A, the central portion defines a foremost region of the expansion member 22′″ with the upper portion and lower portion extending generally aftward of the central portion. In response to application of force by the fascia assembly, the expansion member 22′″ may inelastically deform as illustrated in FIG. 5B. During such deformation, the expansion member 22′″ may dissipate energy from the collision. Moreover, in the deformed configuration illustrated in FIG. 5B, the overall height of the expansion member 22′″ is increased relative to the initial configuration. The bumper assembly 14′″ may thereby provide an increased area for impact forces when necessary, in a similar fashion as the embodiment discussed with respect to FIGS. 2A and 2B.

As may be seen, the present disclosure provides a bumper assembly according to the present disclosure may present a relatively narrow fore portion, providing stylistic freedom and adequate airflow performance, while also enabling desirable bumper performance.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a vehicle body having a width direction, a fore portion, and an aft portion;
a bumper beam coupled to the vehicle body, the bumper beam having a long dimension oriented in the width direction, the bumper beam having a bumper beam height in a vertical direction orthogonal to the width direction;
a fascia assembly coupled to the vehicle body and extending about the bumper beam; and
an expansion member coupled to the bumper beam and disposed between the bumper beam and the fascia assembly, the expansion member having an initial position with respect to the bumper beam and a deployed position with respect to the bumper beam, wherein in the initial position the expansion member presents a first frontal height and in the deployed position the expansion member presents a second frontal height, the second frontal height exceeding the first frontal height and exceeding the bumper beam height, the expansion member being configured to deploy from the initial position to the deployed position in response to contact by the fascia assembly.

2. The automotive vehicle of claim 1, wherein the expansion member is hingedly coupled to the bumper beam, and wherein the expansion member is configured to deploy through pivoting motion about the hinged coupling.

3. The automotive vehicle of claim 2, wherein the hinged coupling has a pivot axis extending generally parallel to the width direction.

4. The automotive vehicle of claim 1, wherein the expansion member comprises a rigid member fixedly coupled to the bumper beam, the expansion member being configured to inelastically deform in response to contact by the fascia.

5. The automotive vehicle of claim 4, wherein the expansion member has an elongate upper portion, an elongate lower portion, and a curved central portion coupling the upper portion to the lower portion, wherein in the initial position the central portion defines a foremost region of the expansion member with the upper portion and lower portion extending generally aftward of the central portion.

6. The automotive vehicle of claim 5, wherein in the deployed position the upper portion extends above the bumper beam and the lower portion extends below the bumper beam.

7. A bumper assembly for an automotive vehicle, comprising:
a bumper beam having a fore side, an aft side, a long dimension, and a bumper beam height in a vertical direction orthogonal to the long dimension; and
an expansion member coupled to the fore side of the bumper beam, the expansion member having an initial position with respect to the bumper beam and a deployed position with respect to the bumper beam, wherein in the initial position the expansion member presents a first frontal height and in the deployed position the expansion member presents a second frontal height, the second frontal height exceeding the first frontal height and exceeding the bumper beam height, the expansion member being configured to deploy from the initial position to the deployed position in response to contact from a body forward of the expansion member.

8. The bumper assembly of claim 7, wherein the expansion member is hingedly coupled to the bumper beam, and wherein the expansion member is configured to deploy through pivoting motion about the hinged coupling.

9. The bumper assembly of claim 8, wherein the hinged coupling has a pivot axis extending generally parallel to the long dimension.

10. The bumper assembly of claim 7, wherein the expansion member comprises a rigid member fixedly coupled to the bumper beam, the expansion member being configured to inelastically deform in response to contact by a body forward of the expansion member.

11. The bumper assembly of claim 10, wherein the expansion member has an elongate upper portion, an elongate lower portion, and a curved central portion coupling the upper portion to the lower portion, wherein in the initial position the central portion defines a foremost region of the expansion member with the upper portion and lower portion extending generally aftward of the central portion.

12. The bumper assembly of claim 11, wherein in the deployed position the upper portion extends above the bumper beam and the lower portion extends below the bumper beam.
